(19) United States
(12) Patent Application Publication
(10) Pub. No.: US 2024/0106055 A1
(43) Pub. Date: Mar. 28, 2024

(54) Structural Battery for Electric Vehicle

(71) Applicants: Hyundai Motor Company, Seoul (KR); Kia Corporation, Seoul (KR); Korea Advanced Institute of Science and Technology, Daejeon (KR)

(72) Inventors: Won Ki Song, Seongnam-si (KR); Jai Hak Kim, Gunpo-si (KR); Chun-Gon Kim, Daejeon (KR); Hyun Wook Park, Daejeon (KR); Joo-Seung Choi, Daejeon (KR); Jung-Eon Noh, Daejeon (KR)

(21) Appl. No.: 18/337,181

(22) Filed: Jun. 19, 2023

(30) Foreign Application Priority Data
Sep. 26, 2022 (KR) 10-2022-0121549

(51) Int. Cl. H01M 50/249; B60K 1/04; B60L 50/71; H01M 4/133; H01M 4/134; H01M 10/28

(52) U.S. Cl. CPC H01M 50/249; B60K 1/04; B60L 50/71; H01M 4/133; H01M 4/134; H01M 10/281; H01M 2220/20

(57) ABSTRACT

An embodiment structural battery for an electric vehicle includes a plurality of cells stacked on each other, each of the plurality of cells including a positive electrode layer, an electrolyte layer, and a negative electrode layer stacked with the electrolyte layer between the positive and negative electrodes, wherein the plurality of cells define a battery by electrical connection of a positive electrode terminal and a negative electrode terminal respectively provided in the plurality of cells, structure reinforcement layers stacked on each of an outermost upper layer and an outermost lower layer of the plurality of cells, and carbon fiber current collecting layers stacked between each of the structure reinforcement layers and the plurality of cells.

### CROSS-REFERENCE TO RELATED APPLICATIONS

This application claims the benefit of Korean Patent Application No. 10-2022-0121549, filed on Sep. 26, 2022, which application is hereby incorporated herein by reference.

### TECHNICAL FIELD

The present invention relates to a structural battery for an electric vehicle.

### BACKGROUND

In general, lithium ion batteries mounted on electric vehicles account for a significant portion of the weight of the electric vehicle, but do not perform any load-bearing function.

On the contrary, as shown in FIG. 1, a structural battery 500 is a part that is installed on a frame or a structure 800 of an electric vehicle woo to support its own load and simultaneously perform charging, discharging, and boosting functions of a high-voltage battery 600 installed on a floor 700 of the vehicle body. That is, the structural battery may serve as a battery while performing the function of the electric vehicle structure.

The battery is also called a mass energy storage device, because when the battery weight becomes a part of the load-bearing structure, there is no battery weight that stores energy. Such a multi-function battery can greatly reduce the weight of the electric vehicle. When the structural battery is applied to an electric vehicle, it is possible to improve a cruising distance by reducing the weight.

In addition, the structural battery has about 20% of the capacity of the lithium ion battery, and although it has a lower capacity than the lithium ion battery, the weight is greatly reduced because there is no separate battery, and consequently, the energy required for the operation of the electric vehicle is reduced.

Furthermore, the structural battery has lower electrical energy density and higher stability.

However, as shown in FIG. 2A and FIG. 2B, a plurality of cells 10, 20, and 30 are stacked to form a multi-cell structure to thereby increase the boosting efficiency of this structural battery. In this case, wiring connected to each cell, an insulating layer stacked between each cell, and the number of current collectors increases thereby increasing the complexity of the assembly and decreasing battery efficiency.

The above information disclosed in this background section is only for enhancement of understanding of the background of embodiments of the invention, and therefore it may contain information that does not form the prior art that is already known to a person of ordinary skill in the art.

### SUMMARY

The present invention relates to a structural battery for an electric vehicle. Particular embodiments relate to a multi-electrode structure of a structural battery for an electric vehicle that can be boosted by being electrochemically connected with a lithium ion battery.

An embodiment of the present invention provides a structural battery for an electric vehicle that can supply power to parts requiring high power using a structural battery of multiple electrode structures formed of a serial connection structure.

In a structural battery for an electric vehicle according to an embodiment of the present invention, a plurality of cells formed by stacking a positive electrode layer, an electrolyte layer, and a negative electrode layer are stacked from top to bottom are stacked, wherein structure reinforcement layers are stacked on each of the outermost upper and lower layers of the plurality of cells, carbon fiber current collecting layers are stacked between the structure reinforcement layer and the plurality of cells, and the plurality of cells are formed into a battery by electrical connection of positive electrode terminals and negative electrode terminals respectively provided in the plurality of cells.

The plurality of cells may be formed of an upper cell and a lower cell, the upper cell may be formed by sequentially stacking the first positive electrode layer, the first electrolyte layer, and the first negative electrode layer from the top to the bottom, the lower cell may be formed by sequentially stacking the second positive electrode layer, the second electrolyte layer, and the second negative electrode layer from the top to the bottom, and a multi-electrode current collecting layer may be stacked between the upper cell and the lower cell.

The multi-electrode current collecting layer may be formed of a conductive solid crystal metal material.

The first and second positive electrode layers and the first and second negative electrode layers each may be formed of a positive electrode active material and a negative electrode active material formed between glass fiber prepregs.

The first and second electrolyte layers may be formed of an electrolyte formed between glass fibers.

The positive electrode terminal and the negative electrode terminal are interposed between the structure reinforcement layer and the carbon fiber current collector layer.

In the structural battery for an electric vehicle according to another embodiment of the present invention, the plurality of cells are formed of an upper cell, a middle cell, and a lower cell, the upper cell is formed by sequentially stacking a first positive electrode layer, a first electrolyte layer, and the first negative electrode layer from top to bottom, the middle cell is formed by sequentially stacking a second positive electrode layer, a second electrolyte layer, and a second negative electrode layer from the top to the bottom, the lower cell is formed by sequentially stacking a third positive electrode layer, a third electrolyte layer, and a third negative electrode layer from the top to the bottom, and a multi-electrode current collecting layer is stacked between the upper cell and the middle cell and between the middle cell and the lower cell, respectively.

The multi-electrode current collecting layer may be formed of a conductive solid crystalline metal.

The first to third positive electrode layers and the first to third negative electrode layers may be formed of a positive electrode active material and a negative electrode active material formed between glass fiber prepregs, respectively.

The first to third electrolyte layers may be formed of an electrolyte formed between the glass fibers.

According to embodiments of the present invention, cost can be reduced by reducing the number of current collectors and wiring per cell compared to the existing structure, and battery resistance can be reduced during voltage boosting by using a structural battery with a multi-electrode structure formed of a serial connection structure.

In addition, a structural battery for an electric vehicle according to an embodiment of the present invention simultaneously performs a battery function and a vehicle body skeleton, enabling weight reduction and improving battery performance and cruising distance.

### BRIEF DESCRIPTION OF THE DRAWINGS

FIG. 1 is a schematic diagram of an electric vehicle to which a structural battery for the electric vehicle according to an embodiment of the present invention is applied.

FIGS. 2A and 2B show a state in which a battery electrode is implemented by stacking a plurality of cells formed of a conventional single electrode structure.

FIG. 3 is a conceptual diagram and an equivalent circuit diagram of a structural battery for an electric vehicle according to an embodiment of the present invention.

FIG. 4 is a cross-sectional view of the structural battery for the electric vehicle in FIG. 3.

FIG. 5 is a conceptual diagram and an equivalent circuit diagram of a structural battery for an electric vehicle according to an embodiment of the present invention.

FIG. 6 is a cross-sectional view of the structural battery for the electric vehicle in FIG. 5.

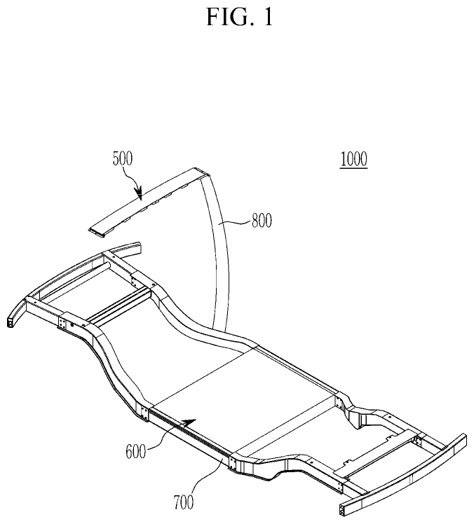

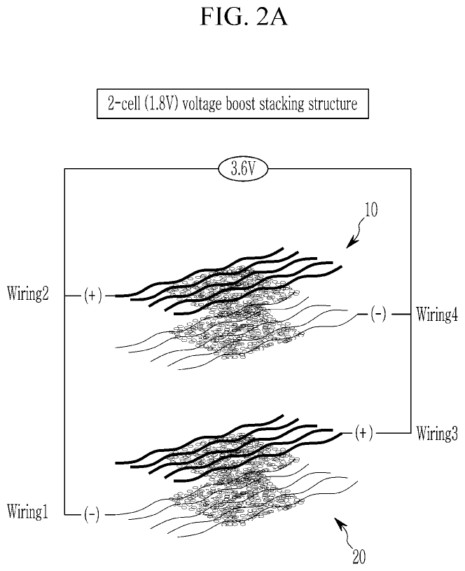

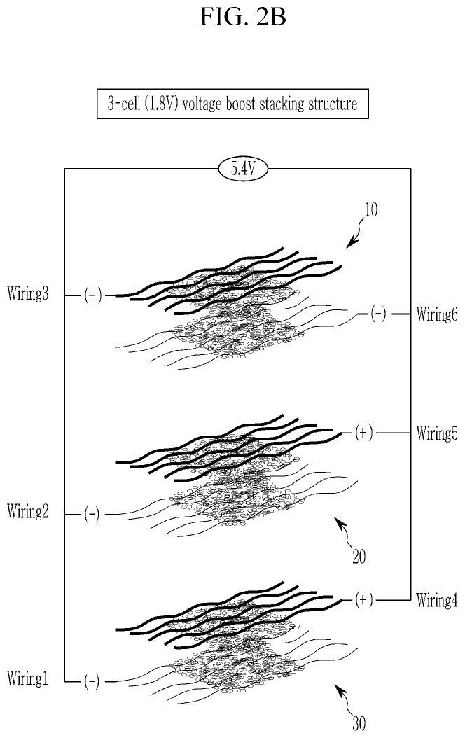

### DETAILED DESCRIPTION OF ILLUSTRATIVE EMBODIMENTS

Hereinafter, with reference to the accompanying drawings, embodiments of the present invention will be described in detail such that a person of ordinary skill in the technical field can easily practice them. The present invention may be implemented in several different forms and is not limited to the embodiments described herein.

In addition, in various embodiments, the same reference numerals are used for representative elements having the same configuration in an embodiment, and in other embodiments, only configurations that are different from the embodiment will be described.

It should be noted that drawings are schematic and not drawn to scale. The relative dimensions and ratios of parts in the drawing are shown exaggerated or reduced in size for clarity and convenience in the drawing, and any dimensions are illustrative only and not limiting. In addition, the same reference sign is used to indicate similar features to the same structure, element, or part appearing in two or more drawings. When a part is referred to as being “on” or “above” another part, it may be directly on top of the other part, or it may be accompanied by the other part in between.

An embodiment of the present invention specifically represents one of embodiments of the present invention. As a result, numerous variations of the illustration are expected. Therefore, an embodiment is not limited to a specific shape of the illustrated area, and includes, for example, a shape modification by manufacturing.

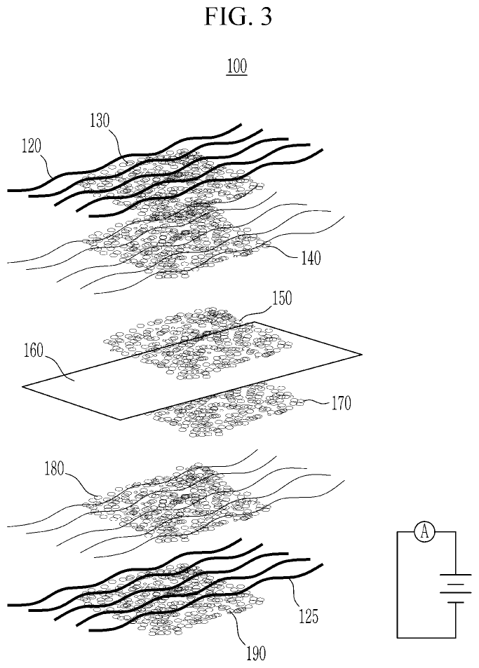

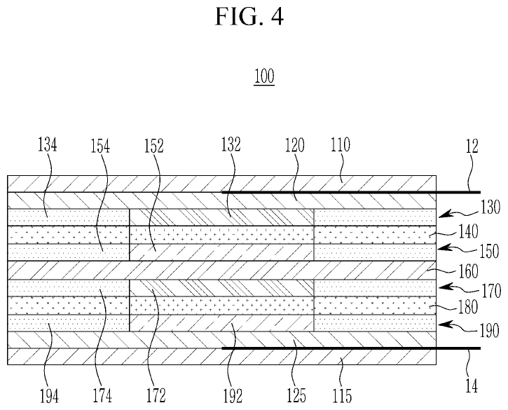

Hereinafter, referring to FIG. 3 and FIG. 4, a structural battery for an electric vehicle according to an embodiment of the present invention will be described.

FIG. 3 is a conceptual diagram and an equivalent circuit diagram of a structural battery for an electric vehicle according to an embodiment of the present invention, and FIG. 4 is a cross-sectional view of the structural battery for the electric vehicle in FIG. 3.

Referring to FIG. 3 and FIG. 4, a structural battery 100 for an electric vehicle according to an embodiment of the present invention may be formed with a structure in which a plurality of cells formed by sequentially stacking positive electrode layers 130 and 170, electrolyte layers 140 and 180, and negative electrode layers 150 and 190 are stacked from top to bottom, structure reinforcement layers no and 115 are stacked on each of the outermost upper and lower layers of the plurality of cells, carbon fiber current collecting layers 120 and 125 are stacked between the structure reinforcement layers no and 115 and the plurality of cells, and the plurality of cells are electrically connected to positive electrode terminals 12 and negative electrode terminals 14 respectively provided in the plurality of cells, thereby forming a battery.

The structural battery for the electric vehicle according to an embodiment of the present invention is formed of an upper cell and a lower cell, and the structure reinforcement layers no and 115 are respectively stacked on the outermost portion of the upper cell and the outermost portion of the lower cell. The structure reinforcement layers 110 and 115 may be formed with carbon fiber prepreg layers, which can improve the strength of structural batteries.

The carbon fiber current collecting layers 120 and 125 are stacked between the structure reinforcement layers no and 115 and each of the upper cell and the lower cell. The carbon fiber current collecting layers 120 and 125 can improve the strength and hardness of structural batteries.

The upper cell may be formed by sequentially stacking the first positive electrode layer 130, the first electrolyte layer 140, and the first negative electrode layer 150 from the top to the bottom, and the lower cell may be formed by sequentially stacking the second positive layer 170, the second electrolyte layer 180, and the second negative electrode layer 190 from the top to the bottom.

In addition, a multi-electrode current collecting layer 160 may be stacked between the upper cell and the lower cell. The multi-electrode current collecting layer 160 may be formed of a conductive solid crystal metal material to prevent contact between the electrodes of the upper cell and the lower cell. The conductive solid crystal metal material may be SUS.

The first and second positive electrode layers 130 and 170 and the first and second negative electrodes layers 150 and 190 may be formed of positive electrode active materials 132 and 172 and negative electrode active materials 152 and 192 formed between glass fiber prepregs 134 and 194, respectively. In addition, the first and second electrolyte layers 140 and 180 may formed of an electrolyte formed between glass fibers.

The positive electrode terminal 12 and the negative electrode terminal 14 may be interposed between the structure reinforcement layers 110 and 115 and the carbon fiber current collecting layers 120 and 125. The upper cell and the lower cell are connected in series through the multi-electrode current collecting layer 160, and the positive electrode terminal 12 and the negative electrode terminal 14 are connected to the wiring drawn out to the outside of the structural battery 100, respectively, and form the entire circuit.

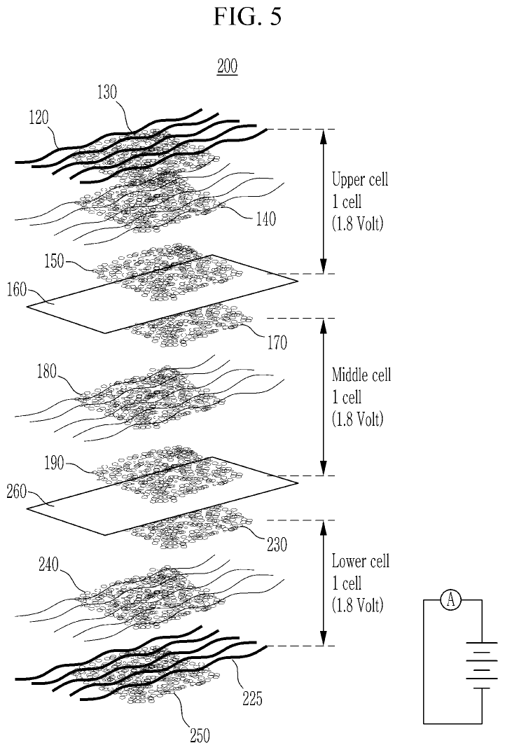

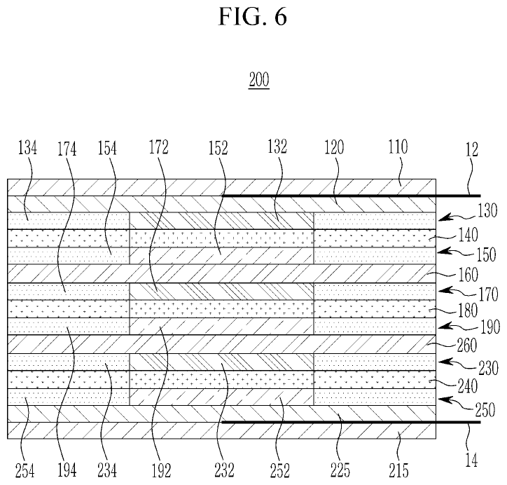

FIG. 5 is a conceptual diagram and an equivalent circuit diagram of a structural battery for an electric vehicle according to an embodiment of the present invention, and FIG. 6 is a cross-sectional view of the structural battery for the electric vehicle in FIG. 5.

Referring to FIG. 5 and FIG. 6, a structural battery 200 for an electric vehicle according to another embodiment of the present invention is formed of an upper cell, a middle cell, and a lower cell, and structure reinforcement layers no and 215 are stacked respectively on the outermost upper portion of the upper cell and the outermost lower portion of the lower cell. Carbon fiber current collecting layers 120 and 225 are stacked between each of the structure reinforcement layers no and 215 and the upper and lower cells.

The upper cell is formed by sequentially stacking the first positive electrode layer 130, the first electrolyte layer 140, and the first negative electrode layer 150 from the top to the bottom, the middle cell is formed by sequentially stacking the second positive electrode layer 170, the second electrolyte layer 180, and the second negative electrode layer 190 from the top to the bottom, and the lower cell is formed by sequentially stacking the third positive electrode layer 230, the third electrolyte layer 240, and the third negative electrode layer 250 from the top to the bottom.

In addition, multi-electrode current collecting layers 160 and 260 are stacked between the upper cell and the middle cell and between the middle cell and the lower cell, respectively. The multi-electrode current collecting layers 160 and 260 may be formed of a conductive solid crystal metal material. The conductive solid crystal metal material may be SUS.

The first to third positive electrodes layers 130, 170, and 230 and the first to third negative electrodes layers 150, 190, and 250 may be formed of positive electrode active materials 132, 172, and 232 and negative electrode active materials 152, 192, and 252 formed between glass fiber prepregs 134, 154, 174, 194, 234, and 254, respectively, and the first to third electrolyte layers 140, 180, and 240 may be formed of an electrolyte formed between glass fibers.

A positive electrode terminal 12 and a negative electrode terminal 14 may be interposed between the structure reinforcement layers no and 215 and the carbon fiber current collecting layers 120 and 225. The upper cell, the middle cell, and the lower cell are connected in series through the multi-electrode current collecting layers 160 and 260, and the positive electrode terminal 12 and the negative electrode terminal 14 are respectively connected to the wiring drawn out to the outside of the structural battery to form the entire circuit.

As such, according to embodiments of the present invention, it is possible to reduce costs by reducing the number of current collectors and wiring per cell compared to the existing structure and to reduce battery resistance when boosting voltage by using a structural battery of a multi-electrode structure formed of a series connection structure.

In addition, the structural battery for an electric vehicle according to an embodiment of the present invention simultaneously performs the battery function and the vehicle body skeleton such that it possible to reduce weight and improve battery performance and cruising distance.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A structural battery for an electric vehicle, the structural battery comprising:
a plurality of cells stacked on each other, each of the plurality of cells comprising a positive electrode layer, an electrolyte layer, and a negative electrode layer stacked with the electrolyte layer between the positive and negative electrodes, wherein the plurality of cells define a battery by electrical connection of a positive electrode terminal and a negative electrode terminal respectively provided in the plurality of cells;
structure reinforcement layers stacked on each of an outermost upper layer and an outermost lower layer of the plurality of cells; and
carbon fiber current collecting layers stacked between each of the structure reinforcement layers and the plurality of cells.

2. The structural battery of claim 1, wherein:
the plurality of cells comprises an upper cell and a lower cell;
the upper cell comprises a first positive electrode layer, a first electrolyte layer, and a first negative electrode layer in a first sequential stack; and
the lower cell comprises a second positive electrode layer, a second electrolyte layer, and a second negative electrode layer in a second sequential stack.

3. The structural battery of claim 2, further comprising a multi-electrode current collecting layer stacked between the upper cell and the lower cell.

4. The structural battery of claim 3, wherein the multi-electrode current collecting layer comprises a conductive solid crystal metal material.

5. The structural battery of claim 3, wherein the first and second positive electrode layers and the first and second negative electrode layers comprise a positive electrode active material and a negative electrode active material disposed between glass fiber prepregs, respectively.

6. The structural battery of claim 3, wherein the first and second electrolyte layers comprise an electrolyte disposed between glass fibers.

7. The structural battery of claim 1, wherein the positive electrode terminal and the negative electrode terminal are interposed between a respective structure reinforcement layer of the structure reinforcement layers and a respective carbon fiber current collector layer of the carbon fiber current collector layers.

8. A structural battery for an electric vehicle, the structural battery comprising:
a plurality of cells stacked on each other and defining a battery by electrical connection of a positive electrode terminal and a negative electrode terminal respectively provided in the plurality of cells, the plurality of cells comprising:
an upper cell comprising a first positive electrode layer, a first electrolyte layer, and a first negative electrode layer sequentially stacked with the first electrolyte layer between the first positive electrode and the first negative electrode;
a middle cell comprising a second positive electrode layer, a second electrolyte layer, and a second negative electrode layer sequentially stacked with the second electrolyte layer between the second positive electrode and the second negative electrode; and
a lower cell comprising a third positive electrode layer, a third electrolyte layer, and a third negative electrode layer sequentially stacked with the third electrolyte layer between the third positive electrode and the third negative electrode;
first and second multi-electrode current collecting layers stacked between the upper cell and the middle cell and between the middle cell and the lower cell, respectively;
structure reinforcement layers stacked on each of an outermost upper layer of the upper cell and an outermost lower layer of the lower cell; and
carbon fiber current collecting layers stacked between the structure reinforcement layers and the plurality of cells.

9. The structural battery of claim 8, wherein the first and second multi-electrode current collecting layers each comprise a conductive solid crystalline metal.

10. The structural battery of claim 8, wherein the first, second, and third positive electrode layers and the first, second, and third negative electrode layers comprise a positive electrode active material and a negative electrode active material disposed between glass fiber prepregs, respectively.

11. The structural battery of claim 8, wherein the first, second, and third electrolyte layers comprise an electrolyte defined between glass fibers.

12. A vehicle comprising:
a vehicle body comprising a floor;
a high-voltage battery disposed on the floor; and
a structural battery coupled to and defining a load supporting part of the vehicle body, the structural battery comprising:
a plurality of cells stacked on each other, each of the plurality of cells comprising a positive electrode layer, an electrolyte layer, and a negative electrode layer stacked from top to bottom, wherein the plurality of cells define a battery by electrical connection of a positive electrode terminal and a negative electrode terminal respectively provided in the plurality of cells;
structure reinforcement layers stacked on each of an outermost upper layer and an outermost lower layer of the plurality of cells; and
carbon fiber current collecting layers stacked between each of the structure reinforcement layers and the plurality of cells.

13. The vehicle of claim 12, wherein:
the plurality of cells comprises an upper cell and a lower cell;
the upper cell comprises a first positive electrode layer, a first electrolyte layer, and a first negative electrode layer in a first sequential stack from the top to the bottom; and
the lower cell comprises a second positive electrode layer, a second electrolyte layer, and a second negative electrode layer in a second sequential stack from the top to the bottom.

14. The vehicle of claim 13, further comprising a multi-electrode current collecting layer stacked between the upper cell and the lower cell.

15. The vehicle of claim 14, wherein the multi-electrode current collecting layer comprises a conductive solid crystal metal material.

16. The vehicle of claim 14, wherein the first and second positive electrode layers and the first and second negative electrode layers comprise a positive electrode active material and a negative electrode active material disposed between glass fiber prepregs, respectively.

17. The vehicle of claim 14, wherein the first and second electrolyte layers comprise an electrolyte disposed between glass fibers.

18. The vehicle of claim 12, wherein the positive electrode terminal and the negative electrode terminal are interposed between a respective structure reinforcement layer of the structure reinforcement layers and a respective carbon fiber current collector layer of the carbon fiber current collector layers.

19. The vehicle of claim 12, wherein:
the plurality of cells comprises an upper cell, a middle cell, and a lower cell;
the upper cell comprises a first positive electrode layer, a first electrolyte layer, and a first negative electrode layer sequentially stacked from the top to the bottom;
the middle cell comprises a second positive electrode layer, a second electrolyte layer, and a second negative electrode layer sequentially stacked from the top to the bottom; and
the lower cell comprises a third positive electrode layer, a third electrolyte layer, and a third negative electrode layer sequentially stacked from the top to the bottom; and
first and second multi-electrode current collecting layers are stacked between the upper cell and the middle cell and between the middle cell and the lower cell, respectively.

20. The vehicle of claim 19, wherein:
the first and second multi-electrode current collecting layers each comprise a conductive solid crystalline metal;
the first, second, and third positive electrode layers and the first, second, and third negative electrode layers comprise a positive electrode active material and a negative electrode active material disposed between glass fiber prepregs, respectively; and
the first, second, and third electrolyte layers comprise an electrolyte defined between the glass fibers.
